(19) United States
(12) Patent Application Publication
(10) Pub. No.: US 2021/0339766 A1
(43) Pub. Date: Nov. 4, 2021

(54) Infrastructure Interaction System and Method

(71) Applicant: Optimus Ride, Inc., Boston, MA (US)

(72) Inventors: SERTAC KARAMAN, Boston, MA (US); Albert Huang, Sunnyvale, CA (US)

(21) Appl. No.: 17/307,431

(22) Filed: May 4, 2021

Related U.S. Application Data
(60) Provisional application No. 63/019,898, filed on May 4, 2020.

(51) Int. Cl. B60W 60/00; B60W 40/06; B60W 40/04

(52) U.S. Cl. CPC B60W 60/001; B60W 40/06; B60W 2555/20; B60W 2552/00; B60W 2556/45; B60W 40/04

(57) ABSTRACT

A method, computer program product, and computing system for receiving situational data from an infrastructure system; processing the situational data to identify one or more AV-impacting conditions; generating AV instructions based, at least in part, upon the one or more AV-impacting conditions; and providing the AV instructions to one or more autonomous vehicles.

### RELATED APPLICATION(S)

This application claims the benefit of U.S. Provisional Application No. 63/019,898 filed on 4 May 2020, the entire contents of which are incorporated herein by reference.

### TECHNICAL FIELD

This disclosure relates to infrastructure and, more particularly, to the interaction of infrastructure with autonomous vehicles.

### BACKGROUND

As transportation moves towards autonomous (i.e., driverless) vehicles, the manufactures and designers of these autonomous vehicle must define contingencies that occur in the event of a failure of one or more of the systems within these autonomous vehicles.

As is known, autonomous vehicles contain multiple electronic control units (ECUs), wherein each of these ECUs may perform a specific function. For example, these various ECUs may calculate safe trajectories for the vehicle (e.g., for navigating the vehicle to its intended destination) and may provide control signals to the vehicle's actuators, propulsions systems and braking systems. Typically, one ECU (e.g., an Autonomy Control Unit) may be responsible for planning and calculating a trajectory for the vehicle, and may provide commands to other ECUs that may cause the vehicle to move (e.g., by controlling steering, braking, and powertrain ECUs).

As would be expected, such autonomous vehicles may need to make navigation decisions that consider their surroundings/environment. And sometimes these autonomous vehicles do not have enough information concerning their surroundings/environment to make a properly informed decision.

### SUMMARY OF DISCLOSURE

In one implementation, a computer-implement method is executed on a computing device and includes: receiving situational data from an infrastructure system; processing the situational data to identify one or more AV-impacting conditions; generating AV instructions based, at least in part, upon the one or more AV-impacting conditions; and providing the AV instructions to one or more autonomous vehicles.

One or more of the following features may be included. Processing the situational data to identify one or more AV-impacting conditions may include: enabling one or more vehicle monitors to process the situational data to identify the one or more AV-impacting conditions. Generating AV instructions based, at least in part, upon the one or more AV-impacting conditions may include: enabling the one or more vehicle monitors to generate the AV instructions based, at least in part, upon the one or more AV-impacting conditions. The one or more vehicle monitors may include: one or more human vehicle monitors. The one or more AV-impacting conditions may include: a dangerous condition; an emergency condition; an inefficient condition; a delay-inducing condition; and an adverse weather condition. The infrastructure system may include one or more of: a portion of a roadway infrastructure system; a portion of a bridge infrastructure system; a portion of a ferry infrastructure system; and a portion of a tunnel infrastructure system. The situational data may include data provided by one or more of: an image-based monitoring system incorporated into the infrastructure system; a weather monitoring system incorporated into the infrastructure system; an environmental monitoring system incorporated into the infrastructure system; and a congestion monitoring system incorporated into the infrastructure system.

In another implementation, a computer program product resides on a computer readable medium and has a plurality of instructions stored on it. When executed by a processor, the instructions cause the processor to perform operations including: receiving situational data from an infrastructure system; processing the situational data to identify one or more AV-impacting conditions; generating AV instructions based, at least in part, upon the one or more AV-impacting conditions; and providing the AV instructions to one or more autonomous vehicles.

One or more of the following features may be included. Processing the situational data to identify one or more AV-impacting conditions may include: enabling one or more vehicle monitors to process the situational data to identify the one or more AV-impacting conditions. Generating AV instructions based, at least in part, upon the one or more AV-impacting conditions may include: enabling the one or more vehicle monitors to generate the AV instructions based, at least in part, upon the one or more AV-impacting conditions. The one or more vehicle monitors may include: one or more human vehicle monitors. The one or more AV-impacting conditions may include: a dangerous condition; an emergency condition; an inefficient condition; a delay-inducing condition; and an adverse weather condition. The infrastructure system may include one or more of: a portion of a roadway infrastructure system; a portion of a bridge infrastructure system; a portion of a ferry infrastructure system; and a portion of a tunnel infrastructure system. The situational data may include data provided by one or more of: an image-based monitoring system incorporated into the infrastructure system; a weather monitoring system incorporated into the infrastructure system; an environmental monitoring system incorporated into the infrastructure system; and a congestion monitoring system incorporated into the infrastructure system.

In another implementation, a computing system includes a processor and memory is configured to perform operations including: receiving situational data from an infrastructure system; processing the situational data to identify one or more AV-impacting conditions; generating AV instructions based, at least in part, upon the one or more AV-impacting conditions; and providing the AV instructions to one or more autonomous vehicles.

One or more of the following features may be included. Processing the situational data to identify one or more AV-impacting conditions may include: enabling one or more vehicle monitors to process the situational data to identify the one or more AV-impacting conditions. Generating AV instructions based, at least in part, upon the one or more AV-impacting conditions may include: enabling the one or more vehicle monitors to generate the AV instructions based, at least in part, upon the one or more AV-impacting conditions. The one or more vehicle monitors may include: one or more human vehicle monitors. The one or more AV-impacting conditions may include: a dangerous condition; an emergency condition; an inefficient condition; a delay-inducing condition; and an adverse weather condition. The infrastructure system may include one or more of: a portion of a roadway infrastructure system; a portion of a bridge infrastructure system; a portion of a ferry infrastructure system; and a portion of a tunnel infrastructure system. The situational data may include data provided by one or more of: an image-based monitoring system incorporated into the infrastructure system; a weather monitoring system incorporated into the infrastructure system; an environmental monitoring system incorporated into the infrastructure system; and a congestion monitoring system incorporated into the infrastructure system.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an autonomous vehicle according to an embodiment of the present disclosure;

FIG. 2A is a diagrammatic view of one embodiment of the various systems included within the autonomous vehicle of FIG. 1 according to an embodiment of the present disclosure;

FIG. 2B is a diagrammatic view of another embodiment of the various systems included within the autonomous vehicle of FIG. 1 according to an embodiment of the present disclosure;

FIG. 3 is a diagrammatic view of another embodiment of the various systems included within the autonomous vehicle of FIG. 1 according to an embodiment of the present disclosure;

FIG. 4 is a diagrammatic view of a plurality of vehicle monitors according to an embodiment of the present disclosure;

FIG. 5 is a diagrammatic view of an infrastructure system according to an embodiment of the present disclosure; and

FIG. 6 is a flowchart of an infrastructure interaction process for interacting with the infrastructure of FIG. 5 according to an embodiment of the present disclosure.

Like reference symbols in the various drawings indicate like elements.

### DETAILED DESCRIPTION OF THE PREFERRED EMBODIMENTS

### Autonomous Vehicle Overview

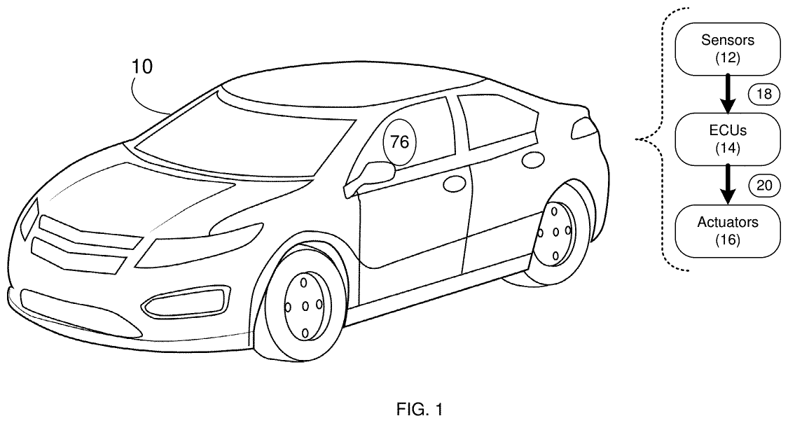

Referring to FIG. 1, there is shown autonomous vehicle 10. As is known in the art, an autonomous vehicle (e.g. autonomous vehicle 10) is a vehicle that is capable of sensing its environment and moving with little or no human input. Autonomous vehicles (e.g. autonomous vehicle 10) may combine a variety of sensor systems to perceive their surroundings, examples of which may include but are not limited to radar, computer vision, LIDAR, GPS, odometry, temperature and inertia, wherein such sensor systems may be configured to interpret lanes and markings on a roadway, street signs, stoplights, pedestrians, other vehicles, roadside objects, hazards, etc.

Autonomous vehicle 10 may include a plurality of sensors (e.g. sensors 12), a plurality of electronic control units (e.g. ECUs 14) and a plurality of actuators (e.g. actuators 16). Accordingly, sensors 12 within autonomous vehicle 10 may monitor the environment in which autonomous vehicle 10 is operating, wherein sensors 12 may provide sensor data 18 to ECUs 14. ECUs 14 may process sensor data 18 to determine the manner in which autonomous vehicle 10 should move. ECUs 14 may then provide control data 20 to actuators 16 so that autonomous vehicle 10 may move in the manner decided by ECUs 14. For example, a machine vision sensor included within sensors 12 may “read” a speed limit sign stating that the speed limit on the road on which autonomous vehicle 10 is traveling is now 35 miles an hour. This machine vision sensor included within sensors 12 may provide sensor data 18 to ECUs 14 indicating that the speed on the road on which autonomous vehicle 10 is traveling is now 35 mph. Upon receiving sensor data 18, ECUs 14 may process sensor data 18 and may determine that autonomous vehicle 10 (which is currently traveling at 45 mph) is traveling too fast and needs to slow down. Accordingly, ECUs 14 may provide control data 20 to actuators 16, wherein control data 20 may e.g. apply the brakes of autonomous vehicle 10 or eliminate any actuation signal currently being applied to the accelerator (thus allowing autonomous vehicle 10 to coast until the speed of autonomous vehicle 10 is reduced to 35 mph).

### System Redundancy

As would be imagined, since autonomous vehicle 10 is being controlled by the various electronic systems included therein (e.g. sensors 12, ECUs 14 and actuators 16), the potential failure of one or more of these systems should be considered when designing autonomous vehicle 10 and appropriate contingency plans may be employed.

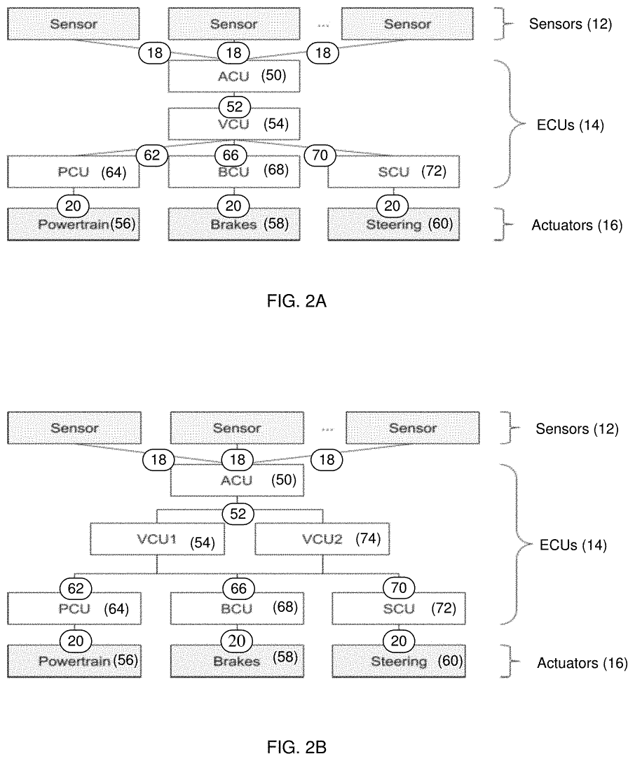

For example and referring also to FIG. 2A, the various ECUs (e.g., ECUs 14) that are included within autonomous vehicle 10 may be compartmentalized so that the responsibilities of the various ECUs (e.g., ECUs 14) may be logically grouped. For example, ECUs 14 may include autonomy control unit 50 that may receive sensor data 18 from sensors 12.

Autonomy control unit 50 may be configured to perform various functions. For example, autonomy control unit 50 may receive and process exteroceptive sensor data (e.g., sensor data 18), may estimate the position of autonomous vehicle 10 within its operating environment, may calculate a representation of the surroundings of autonomous vehicle 10, may compute safe trajectories for autonomous vehicle 10, and may command the other ECUs (in particular, a vehicle control unit) to cause autonomous vehicle 10 to execute a desired maneuver. Autonomy control unit 50 may include substantial compute power, persistent storage, and memory.

Accordingly, autonomy control unit 50 may process sensor data 18 to determine the manner in which autonomous vehicle 10 should be operating. Autonomy control unit 50 may then provide vehicle control data 52 to vehicle control unit 54, wherein vehicle control unit 54 may then process vehicle control data 52 to determine the manner in which the individual control systems (e.g. powertrain system 56, braking system 58 and steering system 60) should respond in order to achieve the trajectory defined by autonomous control unit 50 within vehicle control data 52.

Vehicle control unit 54 may be configured to control other ECUs included within autonomous vehicle 10. For example, vehicle control unit 54 may control the steering, powertrain, and brake controller units. For example, vehicle control unit 54 may provide: powertrain control signal 62 to powertrain control unit 64; braking control signal 66 to braking control unit 68; and steering control signal 70 to steering control unit 72.

Powertrain control unit 64 may process powertrain control signal 62 so that the appropriate control data (commonly represented by control data 20) may be provided to powertrain system 56. Additionally, braking control unit 68 may process braking control signal 66 so that the appropriate control data (commonly represented by control data 20) may be provided to braking system 58. Further, steering control unit 72 may process steering control signal 70 so that the appropriate control data (commonly represented by control data 20) may be provided to steering system 60.

Powertrain control unit 64 may be configured to control the transmission (not shown) and engine/traction motor (not shown) within autonomous vehicle 10; while brake control unit 68 may be configured to control the mechanical/regenerative braking system (not shown) within autonomous vehicle 10; and steering control unit 72 may be configured to control the steering column/steering rack (not shown) within autonomous vehicle 10.

Autonomy control unit 50 may be a highly complex computing system that may provide extensive processing capabilities (e.g., a workstation-class computing system with multi-core processors, discrete co-processing units, gigabytes of memory, and persistent storage). In contrast, vehicle control unit 54 may be a much simpler device that may provide processing power equivalent to the other ECUs included within autonomous vehicle 10 (e.g., a computing system having a modest microprocessor (with a CPU frequency of less than 200 megahertz), less than 1 megabyte of system memory, and no persistent storage). Due to these simpler designs, vehicle control unit 54 may have greater reliability and durability than autonomy control unit 50.

To further enhance redundancy and reliability, one or more of the ECUs (ECUs 14) included within autonomous vehicle 10 may be configured in a redundant fashion. For example and referring also to FIG. 2B, there is shown one implementation of ECUs 14 wherein a plurality of vehicle control units are utilized. For example, this particular implementation is shown to include two vehicle control units, namely a first vehicle control unit (e.g., vehicle control unit 54) and a second vehicle control unit (e.g., vehicle control unit 74).

In this particular configuration, the two vehicle control units (e.g. vehicle control units 54, 74) may be configured in various ways. For example, the two vehicle control units (e.g. vehicle control units 54, 74) may be configured in an active—passive configuration, wherein e.g. vehicle control unit 54 performs the active role of processing vehicle control data 52 while vehicle control unit 74 assumes a passive role and is essentially in standby mode. In the event of a failure of vehicle control unit 54, vehicle control unit 74 may transition from a passive role to an active role and assume the role of processing vehicle control data 52. Alternatively, the two vehicle control units (e.g. vehicle control units 54, 74) may be configured in an active—active configuration, wherein e.g. both vehicle control unit 52 and vehicle control unit 74 perform the active role of processing vehicle control data 54 (e.g. divvying up the workload), wherein in the event of a failure of either vehicle control unit 54 or vehicle control unit 74, the surviving vehicle control unit may process all of vehicle control data 52.

While FIG. 2B illustrates one example of the manner in which the various ECUs (e.g. ECUs 14) included within autonomous vehicle 10 may be configured in a redundant fashion, this is for illustrative purposes only and is not intended to be a limitation of this disclosure, as other configurations are possible and are considered to be within the scope of this disclosure. For example, autonomous control unit 50 may be configured in a redundant fashion, wherein a second autonomous control unit (not shown) is included within autonomous vehicle 10 and is configured in an active—passive or active—active fashion. Further, it is foreseeable that one or more of the sensors (e.g., sensors 12) and/or one or more of the actuators (e.g. actuators 16) may be configured in a redundant fashion. Accordingly, it is understood that the level of redundancy achievable with respect to autonomous vehicle 10 may only be limited by the design criteria and budget constraints of autonomous vehicle 10.

### Autonomy Computational Subsystems

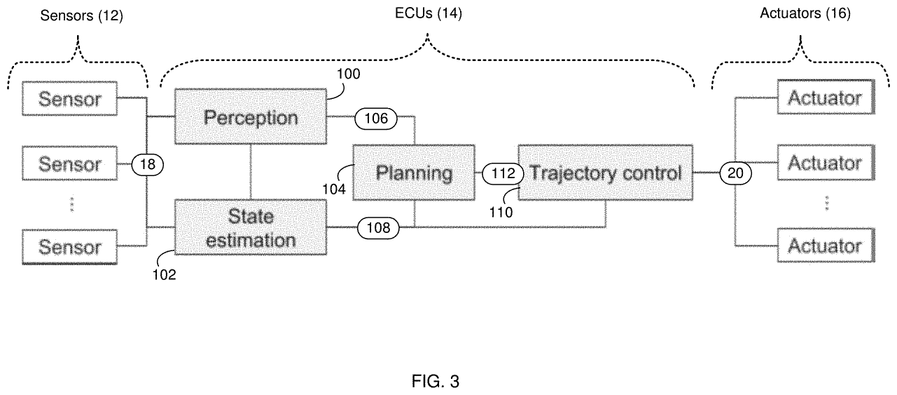

Referring also to FIG. 3, the various ECUs of autonomous vehicle 10 may be grouped/arranged/configured to effectuate various functionalities.

For example, one or more of ECUs 14 may be configured to effectuate/form perception subsystem 100. wherein perception subsystem 100 may be configured to process data from onboard sensors (e.g., sensor data 18) to calculate concise representations of objects of interest near autonomous vehicle 10 (examples of which may include but are not limited to other vehicles, pedestrians, traffic signals, traffic signs, road markers, hazards, etc.) and to identify environmental features that may assist in determining the location of autonomous vehicle 10. Further, one or more of ECUs 14 may be configured to effectuate/form state estimation subsystem 102, wherein state estimation subsystem 102 may be configured to process data from onboard sensors (e.g., sensor data 18) to estimate the position, orientation, and velocity of autonomous vehicle 10 within its operating environment. Additionally, one or more of ECUs 14 may be configured to effectuate/form planning subsystem 104, wherein planning subsystem 104 may be configured to calculate a desired vehicle trajectory (using perception output 106 and state estimation output 108). Further still, one or more of ECUs 14 may be configured to effectuate/form trajectory control subsystem 110, wherein trajectory control subsystem 110 uses planning output 112 and state estimation output 108 (in conjunction with feedback and/or feedforward control techniques) to calculate actuator commands (e.g., control data 20) that may cause autonomous vehicle 10 to execute its intended trajectory within it operating environment.

For redundancy purposes, the above-described subsystems may be distributed across various devices (e.g., autonomy control unit 50 and vehicle control units 54, 74). Additionally/alternatively and due to the increased computational requirements, perception subsystem 100 and planning subsystem 104 may be located almost entirely within autonomy control unit 50, which (as discussed above) has much more computational horsepower than vehicle control units 54, 74. Conversely and due to their lower computational requirements, state estimation subsystem 102 and trajectory control subsystem 110 may be: located entirely on vehicle control units 54, 74 if vehicle control units 54, 74 have the requisite computational capacity; and/or located partially on vehicle control units 54, 74 and partially on autonomy control unit 50. However, the location of state estimation subsystem 102 and trajectory control subsystem 110 may be of critical importance in the design of any contingency planning architecture, as the location of these subsystems may determine how contingency plans are calculated, transmitted, and/or executed.

### Trajectory Calculation

During typical operation of autonomous vehicle 10, the autonomy subsystems described above repeatedly perform the following functionalities of:

1 Measuring the surrounding environment using on-board sensors (e.g. using sensors 12);
Estimating the positions, velocities, and future trajectories of surrounding vehicles, pedestrians, cyclists, other objects near autonomous vehicle 10, and environmental features useful for location determination (e.g., using perception subsystem 100);
Estimating the position, orientation, and velocity of autonomous vehicle 10 within the operating environment (e.g., using state estimation subsystem 102);
Planning a nominal trajectory for autonomous vehicle 10 to follow that brings autonomous vehicle 10 closer to the intended destination of autonomous vehicle 10 (e.g., using planning subsystem 104); and
Generating commands (e.g., control data 20) to cause autonomous vehicle 10 to execute the intended trajectory (e.g., using trajectory control subsystem 110)

During each iteration, planning subsystem 104 may calculate a trajectory that may span travel of many meters (in distance) and many seconds (in time). However, each iteration of the above-described loop may be calculated much more frequently (e.g., every ten milliseconds). Accordingly, autonomous vehicle 10 may be expected to execute only a small portion of each planned trajectory before a new trajectory is calculated (which may differ from the previously-calculated trajectories due to e.g., sensed environmental changes).

### Trajectory Execution

The above-described trajectory may be represented as a parametric curve that describes the desired future path of autonomous vehicle 10. There may be two major classes of techniques for controlling autonomous vehicle 10 while executing the above-described trajectory: a) feedforward control and b) feedback control.

Under nominal conditions, a trajectory is executed using feedback control, wherein feedback trajectory control algorithms may use e.g., a kinodynamic model of autonomous vehicle 10, per-vehicle configuration parameters, and a continuously-calculated estimate of the position, orientation, and velocity of autonomous vehicle 10 to calculate the commands that are provided to the various ECUs included within autonomous vehicle 10.

Feedforward trajectory control algorithms may use a kinodynamic model of autonomous vehicle 10, per-vehicle configuration parameters, and a single estimate of the initial position, orientation, and velocity of autonomous vehicle 10 to calculate a sequence of commands that are provided to the various ECUs included within autonomous vehicle 10, wherein the sequence of commands are executed without using any real-time sensor data (e.g. from sensors 12) or other information.

To execute the above-described trajectories, autonomy control unit 50 may communicate with (and may provide commands to) the various ECUs, using vehicle control unit 54/74 as an intermediary. At each iteration of the above-described trajectory execution loop, autonomy control unit 50 may calculate steering, powertrain, and brake commands that are provided to their respective ECUs (e.g., powertrain control unit 64, braking control unit 68, and steering control unit 72; respectively), and may transmit these commands to vehicle control unit 54/74. Vehicle control unit 54/74 may then validate these commands and may relay them to the various ECUs (e.g., powertrain control unit 64, braking control unit 68, and steering control unit 72; respectively).

### Vehicle Monitors

As discussed above and during typical operation of autonomous vehicle 10, the autonomy subsystems described above may repeatedly perform the following functionalities of: measuring the surrounding environment using on-board sensors (e.g. using sensors 12); estimating the positions, velocities, and future trajectories of surrounding vehicles, pedestrians, cyclists, other objects near autonomous vehicle 10, and environmental features useful for location determination (e.g., using perception subsystem 100); estimating the position, orientation, and velocity of autonomous vehicle 10 within the operating environment (e.g., using state estimation subsystem 102); planning a nominal trajectory for autonomous vehicle 10 to follow that brings autonomous vehicle 10 closer to the intended destination of autonomous vehicle 10 (e.g., using planning subsystem 104); and generating commands (e.g., control data 20) to cause autonomous vehicle 10 to execute the intended trajectory (e.g., using trajectory control subsystem 110).

The operation of autonomous vehicle 10 may be supervised by a vehicle monitor (e.g., a human vehicle monitor). Specifically and in a fashion similar to the manner in which an air traffic controller monitors the operation of one or more airplanes, a vehicle monitor may monitor the operation of one or more autonomous vehicles (e.g., autonomous vehicle 10).

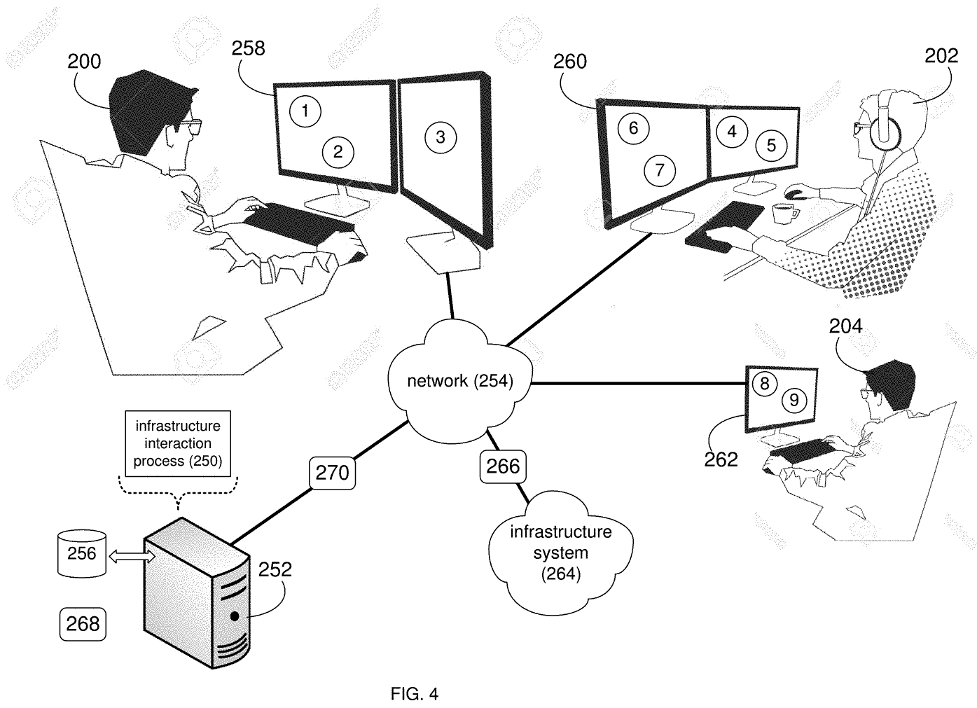

For example and referring also to FIG. 4, vehicle monitors (e.g., vehicle monitors 200, 202, 204) may be located in a centralized location (such as a remote monitoring and operation center) and may monitor the operation of various autonomous vehicles (e.g., autonomous vehicle 10). For example, vehicle monitors 200, 202, 204 may (in this example) be monitoring the operation of nine autonomous vehicles (e.g., autonomous vehicle #1 through autonomous vehicle #9), each of which is represented as a unique circle on the displays of vehicle monitors 200, 202, 204. Specifically and for this example, assume that vehicle monitor 200 is monitoring three autonomous vehicles (i.e., autonomous vehicles 1-3), vehicle monitor 202 is monitoring four autonomous vehicles (i.e., autonomous vehicles 4-7) and vehicle monitor 204 is monitoring two autonomous vehicles (i.e., autonomous vehicles 8-9).

Infrastructure interaction process 250 may be a server application and may reside on and may be executed by computing device 252, which may be connected to network 254 (e.g., the Internet or a local area network). Examples of computing device 252 may include, but are not limited to: a personal computer, a laptop computer, a notebook computer, a server computer, a series of server computers, a mini computer, a mainframe computer, or a cloud-based computing network.

The instruction sets and subroutines of infrastructure interaction process 250, which may be stored on storage device 256 coupled to computing device 252, may be executed by one or more processors (not shown) and one or more memory architectures (not shown) included within computing device 252. Examples of storage device 256 may include but are not limited to: a hard disk drive; a RAID device; a random access memory (RAM); a read-only memory (ROM); and all forms of flash memory storage devices.

Network 254 (e.g., the Internet or a local area network) may couple computing device 252 to the client electronic devices (e.g., client electronic devices 258, 260, 262) utilized by vehicle monitors 200, 202, 204 (respectively). Examples of client electronic devices 258, 260, 262 may include, but are not limited to, a data-enabled, cellular telephone, a laptop computer, a personal digital assistant, a personal computer, a notebook computer, a workstation computer, a smart television, and a dedicated network device. Client electronic devices 258, 260, 262 may each execute an operating system, examples of which may include but are not limited to Microsoft Windows™, Android™, WebOS™, iOS™, Redhat Linux™, or a custom operating system.

Infrastructure system 264 may be coupled to network 254 and may provide situational data 266 to infrastructure interaction process 250. Examples of infrastructure system 264 may include but is not limited to one or more of:
a portion of a roadway infrastructure system, such as the federal interstate highway system, a state highway system, a county highway system, and a local highway system, for example;
a portion of a bridge infrastructure system, such as international bridges, interstate bridges, intrastate bridges, and causeways, for example;
a portion of a ferry infrastructure system, such as international ferries, interstate ferries, and intrastate ferries, for example; and
a portion of a tunnel infrastructure system, such as international tunnels, interstate tunnels, and intrastate tunnels, for example.

Examples of situational data 266 may include but is not limited to data provided by one or more of:
situational data 266 provided by an image-based monitoring system incorporated into infrastructure system 264, such as cameras positioned on street signs, cameras positioned on traffic signals, cameras positioned at intersections, and cameras positioned on roadways/bridges/ferries/tunnels;
situational data 266 provided by a weather monitoring system incorporated into infrastructure system 264, such as weather stations positioned on street signs, weather stations positioned on traffic signals, weather stations positioned at intersections, and weather stations positioned on roadways/bridges/ferries/tunnels;
situational data 266 provided by an environmental monitoring system incorporated into infrastructure system 264, such as ozone/smog monitors positioned on street signs, ozone/smog monitors positioned on traffic signals, ozone/smog monitors positioned at intersections, and ozone/smog monitors positioned on roadways/bridges/ferries/tunnels; and
situational data 266 provided by a congestion monitoring system incorporated into infrastructure system 264, such as traffic flow monitors positioned on street signs, traffic flow monitors positioned on traffic signals, traffic flow monitors positioned at intersections, and traffic flow monitors positioned on roadways/bridges/ferries/tunnels.

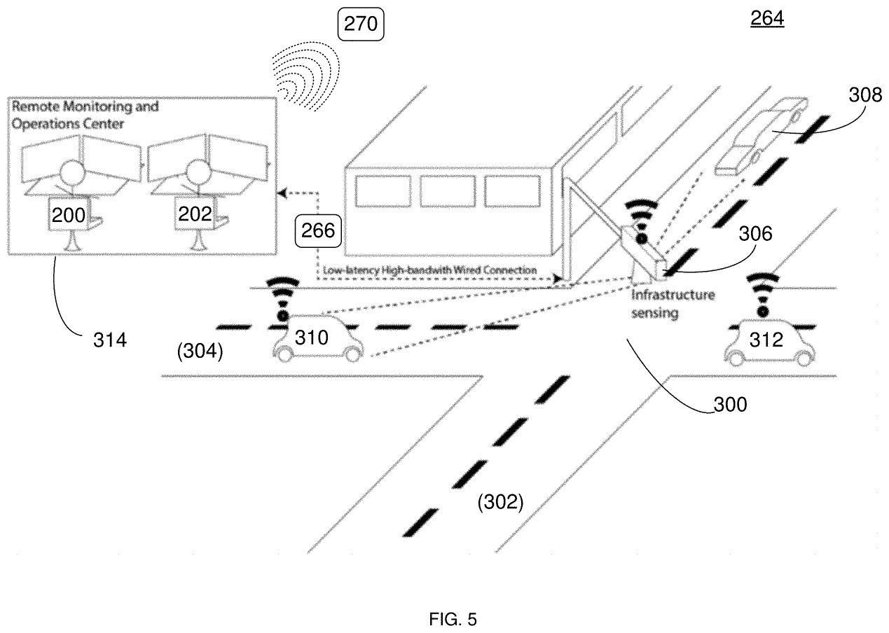

Referring also to FIG. 5, there is shown one example of an infrastructure system (e.g., infrastructure system 264) through which an autonomous vehicle (e.g., autonomous vehicle 10) may travel. In this particular example, infrastructure 264 is an intersection (e.g., intersection 300) of two local roads (e.g., local roads 302, 304). Within infrastructure 264 (generally) and at intersection 300 (specifically), camera 306 is positioned to allow for the observation of traffic that is approaching intersection 300 on roads 302, 304, resulting in the generation of observational data 266. For example, observational data 266 may include video-based information that shows the vehicles that are proximate intersection 300 (e.g., human-driven vehicle 308 and autonomous vehicles 310, 312).

While in the following example, observational data 266 is going to be described as being provided to remote monitoring and operations center 314 (e.g., for review by vehicle monitors 200, 202), this is for illustrative purposes only and is not intended to be a limitation of this disclosure, as other configurations are possible and are considered to be within the scope of this disclosure. For example, observational data 266 may alternatively/additionally be provided to autonomous vehicles 310, 312 travelling near intersection 300.

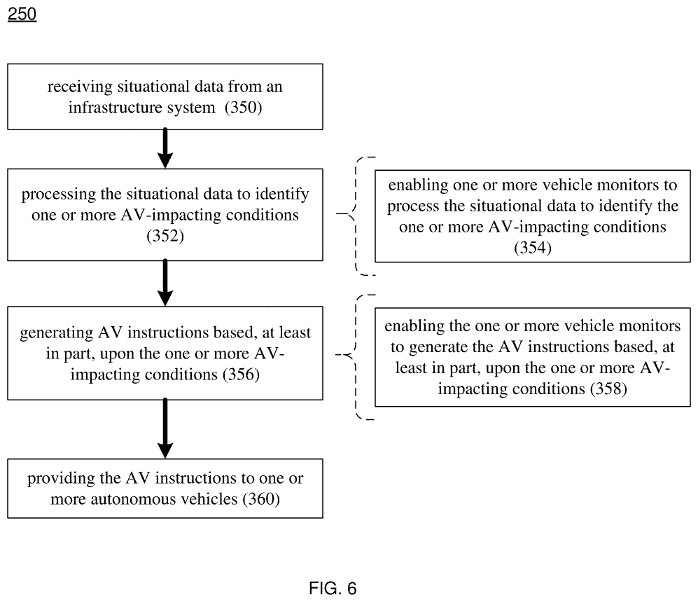

Referring also to FIG. 6, infrastructure interaction process 250 may receive 350 the situational data (e.g., situational data 266) from the infrastructure system (e.g., infrastructure system 264) and may process 352 the situational data (e.g., situational data 266) to identify one or more AV-impacting conditions (e.g., AV-impacting conditions 268). Examples of the one or more AV-impacting conditions (e.g., AV-impacting conditions 268) may include but are not limited to:
a dangerous condition within infrastructure system 264, such as a vehicle (e.g., vehicle 308) rapidly approaching intersection 300 at a rate of speed that may potentially indicate that vehicle 308 may not stop at intersection 300, a hostage situation proximate intersection 300, and a riot/protest proximate intersection 300;
an emergency condition within infrastructure system 264, such as an ambulance (not shown) approaching intersection 300 that will need clear passage through intersection 300, a jumper proximate intersection 300, and a police response proximate intersection 300;
an inefficient condition within infrastructure system 264, such as a high-traffic situation proximate intersection 300, a reduced speed limit situation proximate intersection 300, and a lane-drop situation proximate intersection 300;
a delay-inducing condition within infrastructure system 264, such as an accident proximate intersection 300, a road closure proximate intersection 300, and a structure fire proximate intersection 300; and
an adverse weather condition within infrastructure system 264, such as an icy condition proximate intersection 300, a windy condition proximate intersection 300, and a snowy condition proximate intersection 300.

When processing 352 the situational data (e.g., situational data 266) to identify one or more AV-impacting conditions (e.g., AV-impacting conditions 268), infrastructure interaction process 250 may enable 354 one or more vehicle monitors (e.g., vehicle monitors 200, 202) to process the situational data (e.g., situational data 266) to identify the one or more AV-impacting conditions (e.g., AV-impacting conditions 268). Accordingly and in this example in which the situational data (e.g., situational data 266) is video-based information that shows the vehicles that are proximate intersection 300 (e.g., human-driven vehicle 308 and autonomous vehicles 310, 312), vehicle monitors 200, 202 may process 352 the situational data (e.g., situational data 266) by watching the same to identify the one or more AV-impacting conditions (e.g., AV-impacting conditions 268). Assume for this example that the situational data (e.g., situational data 266) indicates that human-driven vehicle 308 is travelling at a high rate of speed toward a red light at intersection 300 and that human-driven vehicle 308 will likely run the red light at intersection 300. Accordingly, infrastructure interaction process 250 may identify the AV-impacting condition (e.g., AV-impacting condition 268) as a dangerous condition in which human-driven vehicle 308 is likely to run a red light at intersection 300.

Alternatively, infrastructure interaction process 250 may process 352 the situational data (e.g., situational data 266) algorithmically to identify the one or more AV-impacting conditions (e.g., AV-impacting conditions 268) via e.g., artificial intelligence.

Once the one or more AV-impacting conditions (e.g., AV-impacting conditions 268) are identified, infrastructure interaction process 250 may generate 356 AV instructions (e.g., AV instructions 270) based, at least in part, upon the one or more AV-impacting conditions (e.g., AV-impacting conditions 268). When generating 356 the AV instructions (e.g., AV instructions 270) based, at least in part, upon the one or more AV-impacting conditions (e.g., AV-impacting conditions 268), infrastructure interaction process 250 may enable 358 the one or more vehicle monitors (e.g., vehicle monitors 200, 202) to generate the AV instructions (e.g., AV instructions 270) based, at least in part, upon the one or more AV-impacting conditions (e.g., AV-impacting conditions 268). Accordingly and continuing with the example in which infrastructure interaction process 250 identifies the AV-impacting condition (e.g., AV-impacting condition 268) as a dangerous condition in which human-driven vehicle 308 is likely to run a red light at intersection 300, infrastructure interaction process 250 may enable 358 vehicle monitors 200, 202 to generate AV instructions 270 that instruct autonomous vehicles 310, 312 to immediately stop and not enter intersection 300 until this dangerous situation subsides.

Alternatively, infrastructure interaction process 250 may generate 356 AV instructions (e.g., AV instructions 270) based, at least in part, upon the one or more AV-impacting conditions (e.g., AV-impacting conditions 268) algorithmically via e.g., artificial intelligence.

Once infrastructure interaction process 250 generates 356 the AV instructions (e.g., AV instructions 270), infrastructure interaction process 250 may provide 360 the AV instructions (e.g., AV instructions 270) to one or more autonomous vehicle (e.g., autonomous vehicles 310, 312). For example, infrastructure interaction process 250 may wirelessly transmit AV instructions 270 to autonomous vehicles 310, 312.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implement method, executed on a computing device, comprising:
receiving situational data from an infrastructure system;
processing the situational data to identify one or more AV-impacting conditions;
generating AV instructions based, at least in part, upon the one or more AV-impacting conditions; and
providing the AV instructions to one or more autonomous vehicles.

2. The computer-implement method of claim 1 wherein processing the situational data to identify one or more AV-impacting conditions includes:
enabling one or more vehicle monitors to process the situational data to identify the one or more AV-impacting conditions.

3. The computer-implement method of claim 2 wherein generating AV instructions based, at least in part, upon the one or more AV-impacting conditions includes:
enabling the one or more vehicle monitors to generate the AV instructions based, at least in part, upon the one or more AV-impacting conditions.

4. The computer-implement method of claim 3 wherein the one or more vehicle monitors includes:
one or more human vehicle monitors.

5. The computer-implement method of claim 1 wherein the one or more AV-impacting conditions includes:
a dangerous condition;
an emergency condition;
an inefficient condition;
a delay-inducing condition; and
an adverse weather condition.

6. The computer-implement method of claim 1 wherein the infrastructure system includes one or more of:
a portion of a roadway infrastructure system;
a portion of a bridge infrastructure system;
a portion of a ferry infrastructure system; and
a portion of a tunnel infrastructure system.

7. The computer-implement method of claim 1 wherein the situational data includes data provided by one or more of:
an image-based monitoring system incorporated into the infrastructure system;
a weather monitoring system incorporated into the infrastructure system;
an environmental monitoring system incorporated into the infrastructure system; and
a congestion monitoring system incorporated into the infrastructure system.

8. A computer program product residing on a computer readable medium having a plurality of instructions stored thereon which, when executed by a processor, cause the processor to perform operations comprising:
receiving situational data from an infrastructure system;
processing the situational data to identify one or more AV-impacting conditions;
generating AV instructions based, at least in part, upon the one or more AV-impacting conditions; and
providing the AV instructions to one or more autonomous vehicles.

9. The computer program product of claim 8 wherein processing the situational data to identify one or more AV-impacting conditions includes:
enabling one or more vehicle monitors to process the situational data to identify the one or more AV-impacting conditions.

10. The computer program product of claim 9 wherein generating AV instructions based, at least in part, upon the one or more AV-impacting conditions includes:
enabling the one or more vehicle monitors to generate the AV instructions based, at least in part, upon the one or more AV-impacting conditions.

11. The computer program product of claim 10 wherein the one or more vehicle monitors includes:
one or more human vehicle monitors.

12. The computer program product of claim 8 wherein the one or more AV-impacting conditions includes:
a dangerous condition;
an emergency condition;
an inefficient condition;
a delay-inducing condition; and
an adverse weather condition.

13. The computer program product of claim 8 wherein the infrastructure system includes one or more of:
a portion of a roadway infrastructure system;
a portion of a bridge infrastructure system;
a portion of a ferry infrastructure system; and
a portion of a tunnel infrastructure system.

14. The computer program product of claim 8 wherein the situational data includes data provided by one or more of:
an image-based monitoring system incorporated into the infrastructure system;
a weather monitoring system incorporated into the infrastructure system;
an environmental monitoring system incorporated into the infrastructure system; and
a congestion monitoring system incorporated into the infrastructure system.

15. A computing system including a processor and memory configured to perform operations comprising:
receiving situational data from an infrastructure system;
processing the situational data to identify one or more AV-impacting conditions;
generating AV instructions based, at least in part, upon the one or more AV-impacting conditions; and
providing the AV instructions to one or more autonomous vehicles.

16. The computing system of claim 15 wherein processing the situational data to identify one or more AV-impacting conditions includes:
enabling one or more vehicle monitors to process the situational data to identify the one or more AV-impacting conditions.

17. The computing system of claim 16 wherein generating AV instructions based, at least in part, upon the one or more AV-impacting conditions includes:
enabling the one or more vehicle monitors to generate the AV instructions based, at least in part, upon the one or more AV-impacting conditions.

18. The computing system of claim 17 wherein the one or more vehicle monitors includes:
one or more human vehicle monitors.

19. The computing system of claim 15 wherein the one or more AV-impacting conditions includes:
a dangerous condition;
an emergency condition;
an inefficient condition;
a delay-inducing condition; and
an adverse weather condition.

20. The computing system of claim 15 wherein the infrastructure system includes one or more of:
a portion of a roadway infrastructure system;
a portion of a bridge infrastructure system;
a portion of a ferry infrastructure system; and
a portion of a tunnel infrastructure system.

21. The computing system of claim 15 wherein the situational data includes data provided by one or more of:
an image-based monitoring system incorporated into the infrastructure system;
a weather monitoring system incorporated into the infrastructure system;
an environmental monitoring system incorporated into the infrastructure system; and
a congestion monitoring system incorporated into the infrastructure system.
